(19) United States
(12) Patent Application Publication
(10) Pub. No.: US 2014/0000118 A1
(43) Pub. Date: Jan. 2, 2014

(54) YIELDABLE DRIVE MECHANISM FOR A TOE-KICK SAW

(71) Applicant: Crain Cutter Company, Inc., Milpitas, CA (US)

(72) Inventor: Greg Chambers, Morgan Hill, CA (US)

(73) Assignee: Crain Cutter Company, Inc., Milpitas, CA (US)

(21) Appl. No.: 14/014,180

(22) Filed: Aug. 29, 2013

Related U.S. Application Data
(63) Continuation-in-part of application No. 11/858,803, filed on Sep. 20, 2007.

(51) Int. Cl. B23D 45/16

(52) U.S. Cl. CPC B23D 45/16
USPC 30/388

(57) ABSTRACT

A toe-kick saw having a yieldable spindle extension is disclosed. At least one nub, as a transfer member, projects from a first or a second drive plate. The nub is engageable with a depression, slot or other nub receiving area on the other drive plate, to couple and uncouple the plates. In an engaged condition, the drive plates, a secondary spindle, a blade mount and a circular saw blade spin with the saw motor spindle. In a disengaged condition, the first drive plate spins with the saw motor spindle while the second drive plate, secondary spindle, blade mount and saw blade are disengaged from the first drive plate and the saw motor spindle. A biasing mechanism presses the second drive plate towards the first drive plate. A further biasing mechanism may press the second plate towards the first plate with more force when the plates are coupled than when decoupled.

### CROSS-REFERENCE TO RELATED APPLICATION

This application is a continuation-in-part of U.S. non-provisional application Ser. No. 11/858,803, filed Sep. 20, 2007, which claims the benefit of U.S. provisional application No. 60/826,349, filed Sep. 20, 2006; U.S. provisional application No. 60/862,359, filed Oct. 20, 2006; and U.S. provisional application No. 60/942,172, filed Jun. 5, 2007.

### TECHNICAL FIELD

The present device relates generally to flooring installation tools and more specifically to an improved toe-kick saw having enhanced safety features.

### BACKGROUND

A toe-kick saw is a specialty circular saw used in residential floor remodeling. When a finished floor is to be replaced, this often means that the underlayment beneath the finished floor must also be replaced. The “finished floor” is the topmost, exposed layer of flooring selected for décor and utility in the room (typically vinyl, ceramic tile, carpet, hardwood or laminate plank). Beneath the finished floor is underlayment, which is an especially flat, finely finished material. The use of underlayment ensures the finished floor will be installed on a flat surface with no bumps which might poke through the finished floor or create irregularities. Beneath the underlayment is the rough subfloor (normally plywood) which is laid over the joists.

When a finished floor is to be replaced, it is often necessary to replace the underlayment as well. When new vinyl, ceramic tile, or hardwood floors are installed, adhesive is used to adhere the finished floor to the underlayment. In such cases, the finished floor cannot be removed from the underlayment without damaging it.

In many finished floor installations, especially in kitchens and bathrooms, cabinetry is encountered which may have toe-kicks. Toe-kicks are relieved areas at the bottom of the cabinet which allow a person to step closely to the cabinet without stubbing a toe. Often times the cabinetry is installed first before the finished floor is installed, and the cabinetry is installed on top of the underlayment. In the case of a hardwood finished floor, the cabinetry may even be installed on top of the finished floor as well.

Whenever cabinets with toe-kicks are installed on top of the underlayment or finished floor, removing only old underlayment and/or finished floor under the toe-kick can be very difficult. Using conventional hand tools, such as a hammer and chisel, the floor installer would have to chisel out the floor along the entire length of the toe-kick. This chiseling is difficult because the chisel can only be pointed into the corner at a 45 degree angle, not straight downward as required to effectively chisel the material. There is a clear danger of the hammer or chisel striking and damaging the cabinet face. Conventional power saws will not fit underneath the toe space. A specialized power saw is needed which can extend underneath and cut flush up against the inner wall of a toe space.

Toe-kick saws are available for this purpose. As shown in FIG. 1, a typical prior art toe-kick saw 100 consisted of a circular saw motor 120 having a rotating armature (not shown), a primary spindle 140 operatively coupled to the armature, and a means to extend the spindle 150. With respect to the means to extend the spindle, and in regard to both prior art toe-kick saws as well as those of this invention, the preferred means to extend the spindle has included a separate assembly, which will be referred to herein as a “spindle extension assembly” or as a “spindle extension”. However, a separate assembly need not be used. For example, the spindle itself may be elongated. For this reason, the terms elongate spindle, a spindle extension assembly, or a spindle extension shall all be defined and used herein as a means to extend the spindle.

The spindle extension assembly 150 of prior art toe-kick saw 100 includes spindle coupler 160, secondary spindle 200, and set screw 180 which connects spindle coupler 160 and secondary spindle 200. Other means to extend the spindle may be created by persons skilled in the art. For example, a spindle extension may be inserted into a hole in the spindle gear itself and keyed to a slot in the spindle gear. All such will be defined herein as a spindle extension assembly or spindle extension.

The explanation of how spindle extension assembly 150 transmits force to the blade is as follows: Spindle coupler 160 is coupled to primary spindle 140, and also connected to secondary spindle 200 by set screw 180. Thus, when primary spindle 140 turns, secondary spindle 200 is turned. Secondary spindle 200 has flats 210 which may engage flats 310 on blade driver 320. Blade driver 320 has two solid cylindrical drive nubs 330 which engage two drive holes 350 in blade 300. Thus, whenever primary spindle 140 turns, force is transmitted through spindle extension assembly 150 to blade driver 320 and then to blade 300. Blade 300 and blade driver 320 are fastened to secondary spindle 200 by inserting pan head screw 340 into a tapped hole 215 in secondary spindle 200. Blade 300 has a countersunk arbor 370 which accepts the pan-shaped head of pan head screw 340. Thus, pan head screw 340 is flush mounted in blade 300. This allows toe-kick saw 100 to enter a toe-kick and cut flush up to its inner wall.

Spindle extension assembly 150 is covered in use by housing 400. Housing 400 includes face plate 220, tube 240, fixed guard 260, and movable guard 280. Housing 400 is screwed onto saw motor 120 using screws 35. The saw is guided along the inner wall of the toe-kick by the edges 360 of fixed guard 260. Edges 360 extend approximately 1/16″ past the vertical plane defined by blade 300 to prevent blade 300 and countersunk screw 340 from rubbing against the inner wall of the toe-kick. Edges 360 thus place blade 300 as close as possible to the inner wall of the toe-kick, thus cutting off as much of the old flooring material as possible.

The prior art toe-kick saw 100 has a fixed guard 260 which is as small as possible in order to fit in as wide a range of toe-spaces as possible. A small blade guard also enables toe-kick saw 100 to come as close as possible to a wall surface of the room which may abut the toe-kick (such as, an inside corner area). This ensures that the saw may be used within a toe-kick as prescribed by the instructions. However, users commonly misuse toe-kick saws. Despite instructions for proper usage and warnings to use the saw underneath toe-spaces only, and to cut forward and straight along the inner wall of the toe-space only, users misuse the tool by cutting outside the toe-space, by cutting sharp curves, or even by running the saw backwards by pulling it towards themselves. Such abuse may create the dangerous and well-known hazard common in the use of all circular saws called “saw kickback”. Saw kickback is caused when a saw blade may catch or become wedged on the edges of a saw kerf. This results in a sudden stoppage of the blade. Yet the spinning armature of the saw motor still has a great deal of stored kinetic energy. Since the blade is stuck and cannot move, the kinetic energy can cause the saw to react by kicking backward towards the user, creating a laceration hazard. To prevent saw kickback, some means to safely dissipate this stored kinetic energy is needed.

The spindle extension assembly 150 and blade driver 320 of prior art toe-kick saw 100 are unable to safely dissipate the stored kinetic energy. To provide a toe-kick saw which could safely dissipate the energy, it may be noted that the amount of torque in primary spindle 140 (or in spindle extension assembly 150, for that matter) is normally far greater at the time of saw kickback than under normal cutting conditions. A level of spindle torque which is in excess of that which is required for normal cutting, and which may create a kickback hazard, will be referred to herein as an “excess spindle torque”. Some means to disengage the motor and allow the spinning kinetic energy within it to be safely dissipated could reduce kickback hazards created by saw misuse.

There are several prior art torque limiting mechanisms designed to prevent kickback of circular saws, or to prevent damage to a rotary mechanism such as a gearbox, such as U.S. Pat. Nos. 3,080,029 to Stober or 7,137,329B1 to Moser. These include spring loaded drive plates having pockets for ball bearings. The ball bearings act on the pockets based on the concept of an inclined plane. As spindle torque increases, the ball bearings gradually wedge the drive plates apart. At excess spindle torque, the plates disengage, and the ball bearings roll on the outer faces of the drive plates. Torque is gradually dissipated by the balls impacting the pockets. When spindle torque is sufficiently reduced, the spring loading on the plates help ensure that the balls will reseat within the pockets.

The drive plates of these prior art mechanisms involve costly machining due to a number of the aforementioned precision pocket shapes, as well as linkage shapes such as slots and “double-D” features which are necessary. The useful life of these mechanisms is limited due to small impact surfaces on the balls and the pockets. These features do not last very long due to very heavy impacts, which during disengagement occur at a very rapid frequency.

Drive plates having integral nubs and slots in place of the balls and machined pockets could be formed as metal stamping shapes at much lower cost. The nubs and slots could be formed with wider drive surfaces than the prior art ball bearings and pockets for better impact resistance and longer life. With the use of powdered metal manufacturing methods, the plates could be formed in combination with other separate linkage shapes of prior art torque limiting mechanisms to reduce the number of parts and manufacturing cost.

Another weakness of the prior art designs was that the spring used to pressure one drive plate against the other were typically simple coil springs producing heavy pressure during disengagement of the plates. A biasing mechanism that could work to reduce pressure once the drive plates entered a disengaged condition could reduce impact wear on the plates and increase useful life.

### SUMMARY

A toe-kick saw having a yieldable spindle extension is herein described. The toe-kick saw is of a type having a saw motor spindle. The toe-kick saw is further of a type to which a circular saw blade is securable at a blade mount.

The yieldable spindle extension includes a first drive plate and a second drive plate which may be a male drive plate and a female drive plate. The yieldable spindle extension further includes a biasing mechanism and a secondary spindle, and may include a spindle coupler. The first drive plate is operatively connected to or driven by the saw motor spindle, as by the spindle coupler. The second drive plate couples to and decouples from the first drive plate.

A transfer member projects from one of the first and second drive plates. In a first example, one or more transfer members projects from one of the first and second drive plates and is insertable within a corresponding one or more depressions of the other of the first drive plate and second drive plate. In a second example, the transfer member includes a male nub on a male drive plate. The male drive plate is operatively coupled to the spindle coupler, which is attachable to the saw motor spindle. A female drive plate has at least one female slot for receiving the at least one male nub of the male drive plate. In a third example, the transfer member includes at least a nub projecting from one of the first and second drive plates that is engageable with a nub receiving area on the other of the first and second drive plates.

The secondary spindle interacts with the drive plates and the circular saw blade. In the first example, the secondary spindle holds the first drive plate, the second drive plate, the one or more transfer members and a spring. The first drive plate, second drive plate, one or more transfer members and spring are positioned on a longitudinal axis of the secondary spindle. In the second example, the secondary spindle has a blade fastener hole and holds the spindle coupler, the male drive plate, the female drive plate and a biasing mechanism. The first drive plate, second drive plate, one or more transfer members, and the biasing mechanism are positioned on a longitudinal axis of the secondary spindle. The secondary spindle is operatively coupled to the female drive plate such that when the female drive plate is coupled to and turned by the male drive plate, the secondary spindle is turned. In the third example, the secondary spindle is driven by the second drive plate.

One or more biasing mechanisms are provided. In the first example, the spring held by the secondary spindle yieldably presses the second drive plate against the first drive plate. In the second example, a biasing mechanism yieldably presses the female drive plate against the male drive plate. In the third example, a first biasing mechanism presses the second drive plate towards the first drive plate and has at least a portion extending and collapsing coaxially with the secondary spindle. Further, in the third example a second biasing mechanism presses the second drive plate towards the first drive plate with more force in a coupled or a partly coupled condition of the first and second drive plates than in a decoupled condition of the first and second drive plates.

An engaged condition of the yieldable spindle extension includes the first drive plate, second drive plate, secondary spindle, blade mount and the saw blade spinning with the saw motor spindle. A disengaged condition of the yieldable spindle extension includes the first drive plate spinning with the saw motor spindle and includes the second or female drive plate, the secondary spindle, blade mount and the saw blade being stopped or disengaged from the first or male drive plate. The decoupled condition includes the second drive plate, the secondary spindle, a blade mount and the circular saw blade being decoupled from the first drive plate and the saw motor spindle.

### BRIEF DESCRIPTION OF THE DRAWINGS

FIG. 1 is a partially exploded view of a prior art toe-kick saw.

FIG. 2a is an exploded view of a toe-kick saw with a yieldable blade driver.

FIG. 2b is a front perspective view of the yieldable blade driver.

FIG. 3 is partially exploded view of an alternative embodiment of the yieldable blade driver in FIGS. 2a and 2b, in which the blade driver is made from two pieces of material.

FIG. 4 is a partially exploded view of an alternative embodiment of a yieldable blade driver which includes a solid blade driver and a dished washer.

FIG. 5 is an exploded view of a toe-kick saw with a spindle extension assembly which contains a pair of spring loaded drive plates.

FIG. 6 is an exploded view of a toe-kick saw a having a yieldable spindle extension that includes a male drive plate having male nubs, and a female drive plate having female slots, and a biasing mechanism of a spring assembly capable of reducing pressure during disengagement.

FIG. 7 is a fully assembled top view of the yieldable spindle extension of FIG. 6 in isolation with the male drive plate and the female drive plate engaged with one another.

FIG. 7A is a view of cross section A-A of FIG. 7.

FIG. 8 is another fully assembled top view of the yieldable spindle extension of FIG. 6 in isolation, but with the male drive plate and the female drive plate disengaged with one another.

FIG. 8A is a view of cross section B-B of FIG. 8.

FIG. 9 is a perspective view of the spring body component of the yieldable spindle extension of FIG. 6.

FIG. 10 is a perspective view of the spring body and female drive plate components of FIG. 6 combined and formed from a single piece of material, referred to herein as a female spring body.

FIG. 11 is a reverse angle view of the female spring body of FIG. 10.

FIG. 12 is a perspective view of the male drive plate and spindle coupler of FIG. 6 combined and formed from a single piece of material, referred to as a male coupler.

FIG. 13 is a reverse angle view of the combined male coupler of FIG. 12.

FIG. 14 is a top view of the male drive place, including a cross section of a male nub.

FIG. 14A is a view of cross section C-C of FIG. 14.

FIG. 15 is a top view of the female drive plate, including a cross section of a female slot.

FIG. 15A is a view of cross section D-D of FIG. 15.

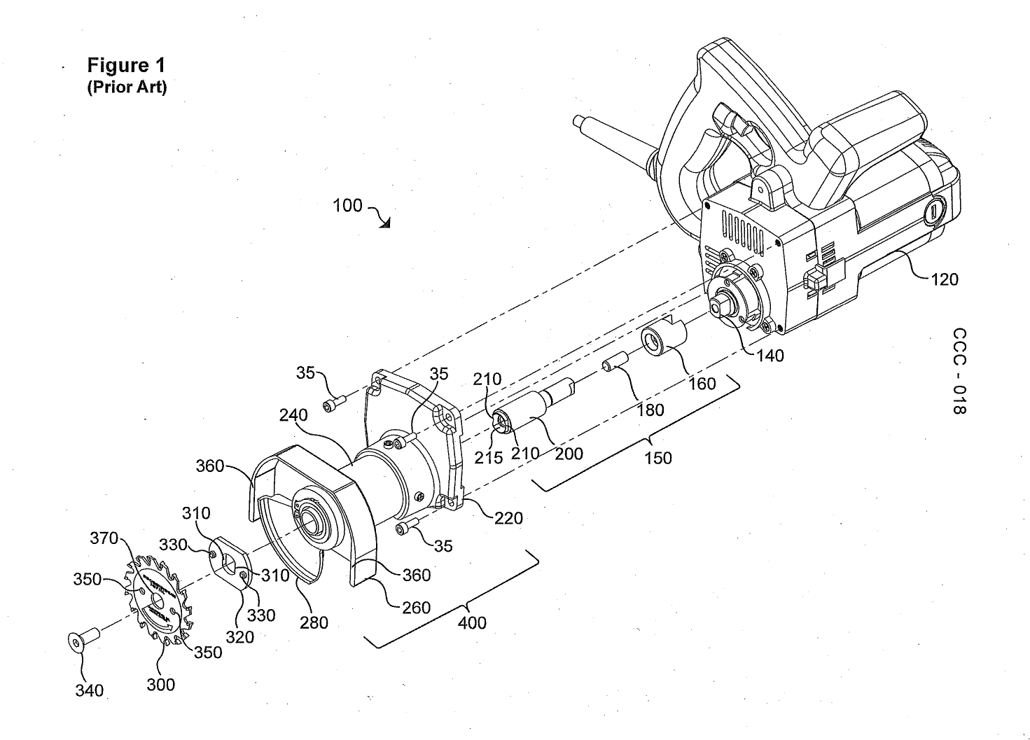

### DETAILED DESCRIPTION

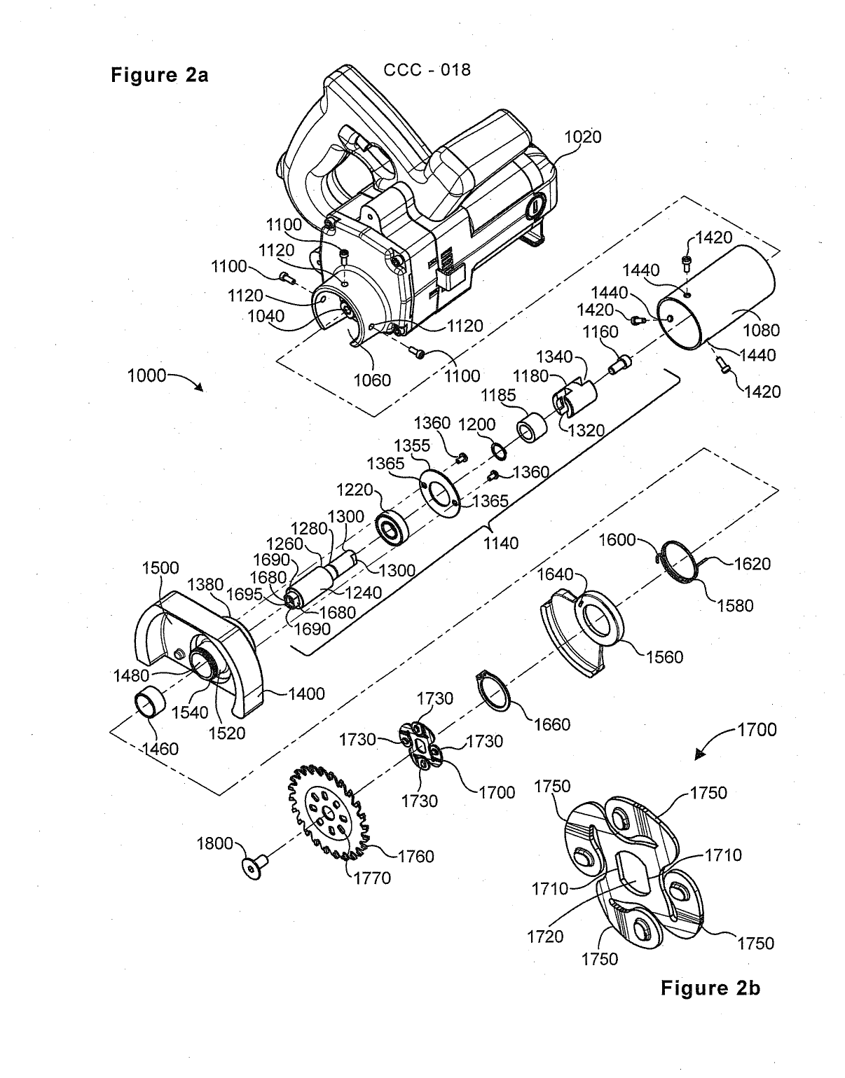

With reference to FIG. 2a, toe-kick saw 1000 includes a circular saw motor 1020 having an internal rotating armature (not shown) operatively coupled to a rotating spindle 1040. The housing of motor 1020 has an opening 1060 which accepts tube 1080. Tube 1080 is inserted and fastened into opening 1060 with three screws 1100 which run through three holes 1120.

Tube 1080 serves to house spindle extension assembly 1140. Spindle extension assembly 1140 includes screw 1160, spindle coupler 1180, spacer 1185, snap ring 1200, ball bearing 1220, and secondary spindle 1240. The assembly of these components goes as follows: Ball bearing 1220 is slipped onto secondary spindle 1240 and rests on shoulder 1260. Snap ring 1200 is seated in groove 1280. Spacer 1185 is then slipped onto secondary spindle 1240.

Next in the assembly is the mounting of spindle coupler 1180. Spindle coupler 1180 has a slot 1320 which accepts flats 1300 on secondary spindle 1240. Spindle coupler 1180 has a slot 1340 on the opposite end and a hole through its centerline (not shown). Screw 1160 goes through this centerline hole and fastens into a tapped centerline hole (not shown) on the inside end of secondary spindle 1240.

Once spindle coupler 1180 is fixed onto secondary spindle 1240, it may form a coupling for spindle extension assembly 1140 when slot 1340 is coupled to spindle 1040 (of motor 1020). Thus, spindle extension assembly 1140 is capable of transmitting force from saw motor 1020 to a blade driver at an extended distance.

Spindle extension assembly 1140 is housed within tube 1080. As previously explained, tube 1080 is inserted and fastened into opening 1060 of saw motor 1020. On the opposite end, tube 1080 is press fit onto boss 1380 on the back side of fixed guard 1400 and fastened with three screws 1420 through three holes 1440.

Internal support for spindle extension assembly 1140 is provided within fixed guard 1400 by ball bearing 1220 and bushing 1460. Bushing 1460 is press fit into a reamed counterbored hole 1480. Hole 1480 runs from the front of fixed guard 1400 all the way through to the opposite side of fixed guard 1400, where said counterbore (not shown) is located. Spindle extension assembly 1140 is then inserted though the back side of hole 1480 and bushing 1460 until ball bearing 1220 seats in said counterbore. Plate 1355 is placed on top of ball bearing 1220. Two screws 1360 are fastened into fixed guard 1400 through two holes 1365 in plate 1355. This fastens ball bearing 1220 into the counterbore and secures spindle extension assembly 1140 into fixed guard 1400.

When ball bearing 1220 is seated and fastened into said counterbore, the secondary spindle is prevented from sliding out by snap ring 1200. Spacer 1185 provides additional safety should snap ring 1200 fail. Spacer 1185 is larger in outside diameter than the center hole in ball bearing 1220, and thus also prevents spindle extension assembly 1140 from sliding out.

Practical problems of imprecise bearing alignment, runout, and motor vibration make manufacturing a circular saw with an extended spindle difficult. Connecting a separate secondary spindle (such as secondary spindle 1240) to the motor by way of spindle coupler 1180 is preferred because a controllable amount of play is allowed in the juncture between slot 1340 and primary spindle 1040. Without such play, even slight misalignment will result in runout or wobbling forces being transferred to ball bearing 1220 and bushing 1460. This reduces the life of the saw.

Fixed guard 1400 has a blade housing 1500 which contains cylindrical guard mount 1520. As with prior art toe-kick saws, a torsion spring 1580 and movable guard 1560 is placed onto cylindrical guard mount 1520. Torsion spring 1580 hooks on end 1620 into a hole inside blade housing 1500 (not shown) and on hook 1600 to a hole 1640 on primary movable guard 1560. When primary movable guard 1560 is retracted (as during a cutting operation), tension builds in torsion spring 1580 which urges primary movable guard 1560 to re-extend back to a forward guarding position. Cylindrical guard mount 1520 has snap ring groove 1540. Snap ring 1660 is seated into snap ring groove 1540 to hold primary movable guard 1560 and torsion spring 1580 in place.

The distal end of secondary spindle 1240 projects a sufficient distance into blade housing 1500 to expose flats 1680 and rounds 1690. Flats 1680 form the drive surfaces for a blade driver. Yieldable blade driver 1700 is mounted on the distal end of secondary spindle 1240. As shown more clearly in FIG. 2b, flats 1710 in arbor 1720 engage flats 1680 of secondary spindle 1240 (FIG. 2a). Thus, force is transmitted from the secondary spindle 1240 (FIG. 2a) to yieldable blade driver 1700. As shown in FIG. 2a, blade 1760 is next placed on the distal end of secondary spindle 1240 where it rests on rounds 1690. Blade 1760 is pressed against four spherical nubs 1730 of yieldable blade driver 1700. The four spherical nubs may seat in any four of eight concentric drive holes 1770 in blade 1760. Blade screw 1800 is fastened into a tapped hole 1695 in the distal end of secondary spindle 1240 to hold blade 1760 and yieldable blade driver 1700 on secondary spindle 1240. However, blade screw 1800 can tighten down only enough to leave a small gap between its inside surface and the outer surface of blade 1760. This gap is controlled by the depth of tapped hole 1695 in the end of secondary spindle 1240. Under normal cutting conditions, yieldable blade driver 1700 will transmit sufficient force to blade 1760 for cutting.

At excess spindle torque, the four of holes 1770 in blade 1760 which may be engaged with rounded nubs 1730 produce sufficient wedging pressure on nubs 1730 to bend arms 1750 (FIG. 2b) of yieldable blade driver 1700 backward. Thus nubs 1730 become disengaged from blade 1760. Blade 1760 stops. (The previously discussed small gap between the inside surface of blade screw 1800 and the inside surface of blade 1760 isolates blade 1760 from blade screw 1800. Rounds 1690 transfer little or no force.) The spinning kinetic energy of the motor is safely dissipated as the nubs 1730 of yieldable blade driver 1700 ratchet against the eight concentric drive holes 1770 of blade 1760. When motor power is sufficiently reduced, nubs 1730 may reseat in any four of eight concentric drive holes 1770. This allows yieldable blade driver 1700 to re-engage the blade, so that cutting at reduced spindle torque may resume. The nubs are illustrated as rounded nubs (i.e. the projecting ends of the nubs are curved) but any shape which causes the blade driver to yield and disengage from the blade at excess spindle torque, and thereafter reengage the blade at lower spindle torque, should be adaptable to the present embodiments (including those of FIGS. 2a, 2b, 3 and 4). Thus a nub with a facet or inclined end is also envisioned. The nubs illustrated are spherical (rounded ends) but any shape allowing unseating/reseating of the blade would be possible. Faceted heads are envisioned.

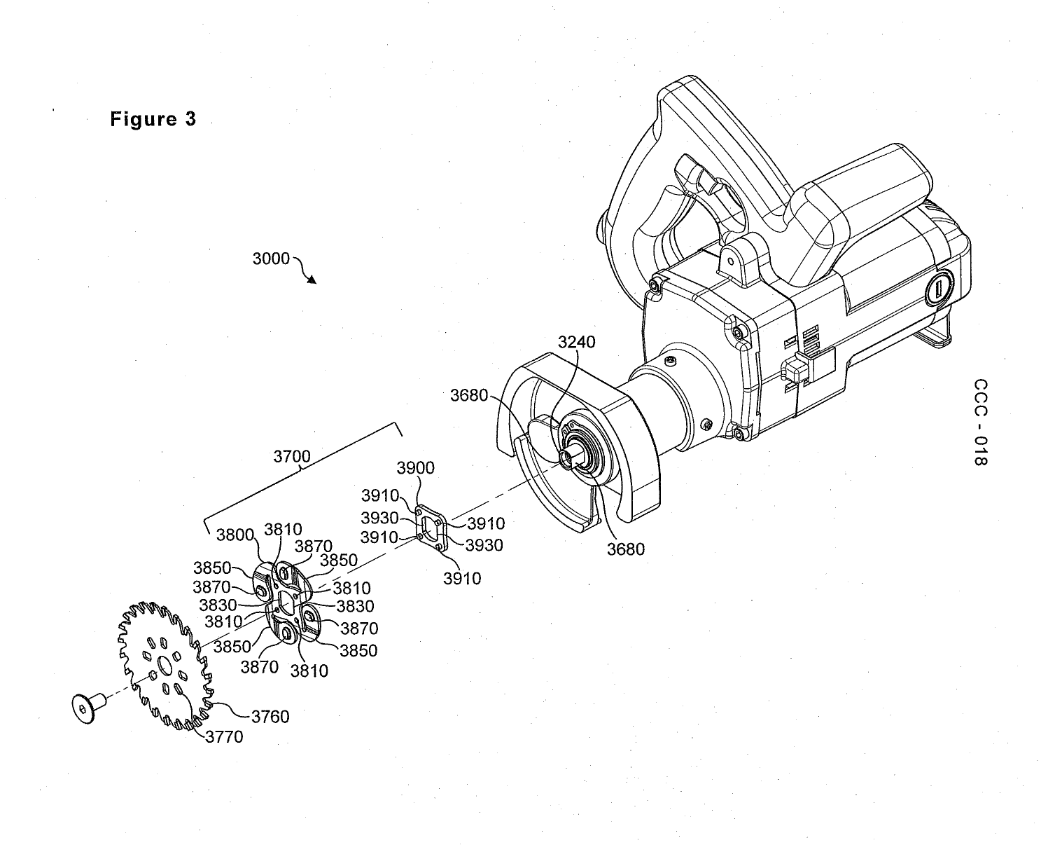

A yieldable blade driver for a toe-kick saw may have several embodiments. In another embodiment, the driver may be made in two parts in order to reduce the thickness of the arms. As shown in the toe-kick saw 3000 of FIG. 3, yieldable blade driver 3700 consists of a first driver 3800 and a second back up plate 3900. Driver 3800 and back up plate 3900 are made to be spot welded or peened together as by inserting bosses 3910 of backup plate 3900 through holes 3810 of blade driver 3800. The combined thickness of flats 3830 of driver 3800 with flats 3930 of backup plate 3900 is comparable to the thickness of flats 1710 of the single piece yieldable blade driver 1700 of FIG. 2b. Thus, the bearing surface of the combined flats 3830, 3930 which bear against the drive flats 3680 on the secondary spindle 3240 will be comparable. This prevents premature wear on secondary spindle 3240. However, as shown in FIG. 3, the material used to form driver 3800 may be thinner. Using thinner materials to form arms 3850 is preferred for two reasons. First, thinner arms allow the four spherical nubs 3870 to disengage at lower spindle torque. Secondly, the thickness of arms 3850 determines the pressure put on the spherical nubs 3870 when they ratchet against the drive holes 3770 in the blade 3760 when the yieldable blade driver is disengaged. The reduced pressure from arms 3850 helps spherical nubs 3870 last longer.

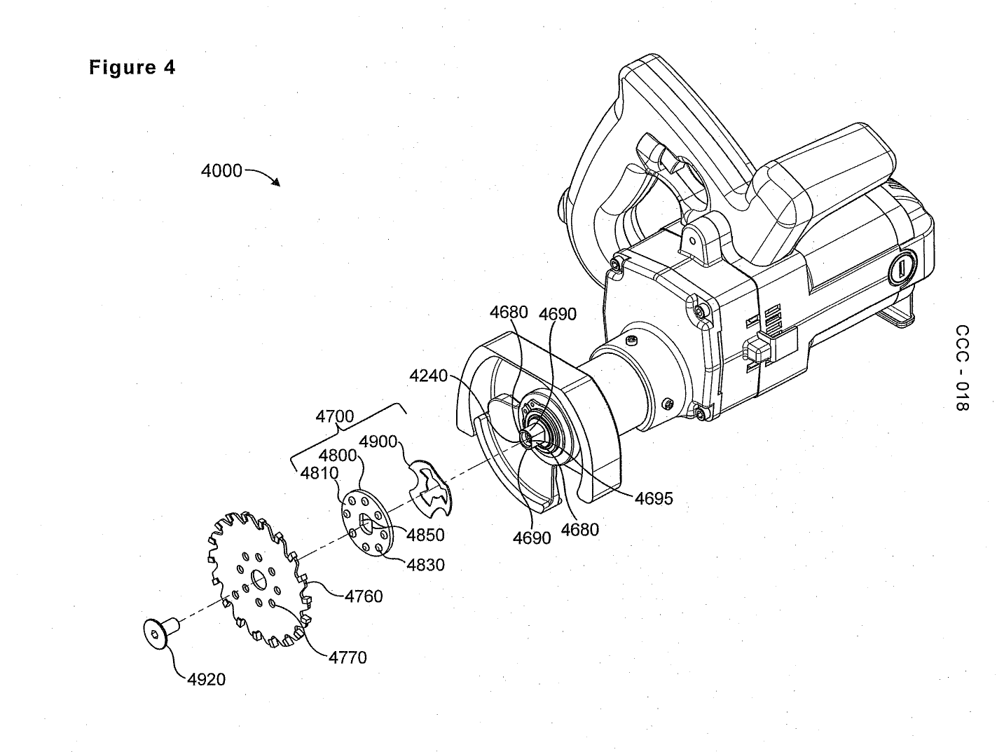

Another embodiment of a yieldable blade driver for a toe-kick saw which uses a combination of a solid driver and a dished washer is shown in FIG. 4. Yieldable blade driver 4700 includes solid driver 4800 and dished washer 4900 which acts like a spring. Dished washer 4900 is installed first on the end of secondary spindle 4240, followed by solid driver 4800. Solid driver 4800 is pressed against dish washer 4900. Solid driver 4800 has a thicker solid body 4810 which will not bend, and a concentric pattern of eight spherical drive nubs 4830. Force for driving the blade is transmitted from flats 4680 on the secondary spindle 4240 of toe-kick saw 4000 to flats 4850 of solid driver 4800. Under normal cutting conditions, solid driver 4800 will transfer sufficient force for cutting, with each of its eight spherical drive nubs 4830 driving against the concentric pattern of eight drive holes 4770 in blade 4760. However, as spindle torque increases, eight spherical drive nubs 4830 tend to wedge solid driver 4800 away from blade 4760, which puts pressure on dish washer 4900 and causes it to yield. At excess spindle torque, solid driver 4800 disengages from blade 4760, and the eight spherical drive nubs 4830 ratchet against the eight drive holes 4770 of blade 4760. Blade 4760 stops. (Secondary spindle 4240 of toe-kick saw 4000 has the same threaded hole 4690 with precise depth that maintains a small gap between the inner surface of screw 4920 and blade 4760, and rounds 4690 which both prevent any force from being transferred to blade 4760 during disengagement.) The spinning kinetic energy of the motor may be dissipated by the ratcheting of solid driver 4800 against blade 4760. Once the kinetic energy is sufficiently dissipated, dish washer 4900 will urge solid driver 4800 against blade 4760 with sufficient force to reengage the eight spherical drive nubs 4830 into the eight drive holes 4770 of blade 4760, and normal cutting may resume.

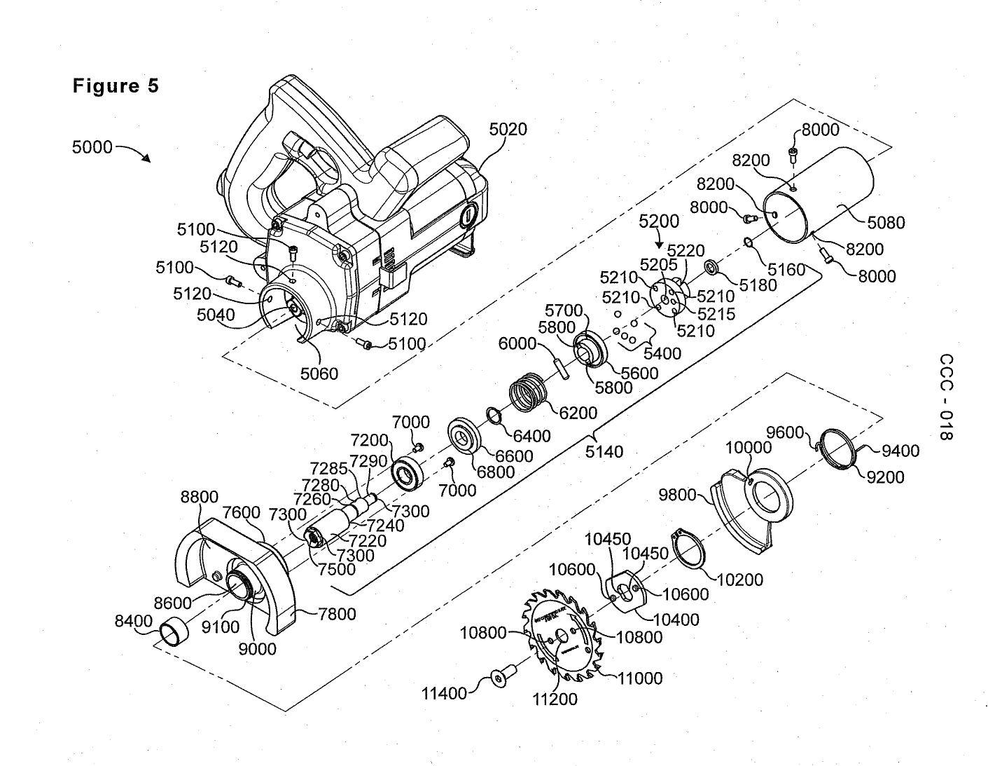

A different type of yieldable drive mechanism for a toe-kick saw may be a yieldable spindle extension. A yieldable spindle extension may include a pair of spring loaded drive plates which may allow the spindle extension assembly to disengage itself from the saw motor at excess spindle torque. As shown in FIG. 5, toe-kick saw 5000 includes a motor 5020 with a rotating armature (not shown) operatively coupled to a rotating spindle 5040. The housing of motor 5020 has an opening 5060 which accepts tube 5080. Tube 5080 is inserted and fastened into opening 5060 with three screws 5100 which run through three holes 5120.

Tube 5080 serves to cover yieldable spindle extension 5140. Yieldable spindle extension 5140 includes wire-form retainer ring 5160, chamfered washer 5180, primary drive plate 5200, five steel balls 5400, secondary drive plate 5600, lock pin 6000, spring 6200, snap ring 6400, washer 6600, ball bearing 7200, and secondary spindle 7220. The assembly of these components goes as follows: Ball bearing 7200 is slid onto secondary spindle 7220 and rests on shoulder 7240. Washer 6600 is next slid onto secondary spindle 7220. Washer 6600 has a step 6800 which rests on the inside race (not shown) on the inside face of ball bearing 7200. Snap ring 6400 seats in first groove 7260 to lock ball bearing 7200 and washer 6600 in place.

Pin 6000 is inserted into a hole 7280 through secondary spindle 7220. Spring 6200 is placed over secondary spindle 7220 and is pressed on one end against washer 6600. On the opposite end, spring 6200 is pressed against a groove 5700 on secondary drive plate 5600 until the ends of pin 6000 seat in drive slots 5800 of secondary drive plate 5600. Five steel balls 5400 are inserted into five detents (not shown) on the inner face of secondary drive plate 5600. Four of these detents are concentric, while the one other detent is located on a shorter radius inside the concentric circle formed by the other four detents. Primary drive plate 5200 is placed against the inner face of secondary drive plate 5600 such that the five steel balls 5400 seat in five detents 5210, 5215 in primary drive plate 5200. The number and location of detents in primary drive plate 5200 correspond with those in the inner face of secondary drive plate 5600 (i.e., four detents 5210 are concentric, one detent 5215 is located on a shorter radius).

For reasons to be explained later in the discussion of how primary drive plate 5200 and secondary drive, plate 5600 may disengage in use, the detents 5210, 5215 in primary drive plate 5200 are slightly deeper than those in secondary drive plate 5600. However, in the initial assembly, the two sets of detents in both primary drive plate 5200 and secondary drive plate 5600 are aligned to precisely define five cavities for holding five steel balls 5400.

To complete the assembly of the yieldable spindle extension 5140, primary drive plate 5200 is pressed onto the assembly of five steel balls 5400 and secondary drive plate 5600, until it slips over end 7290 of secondary spindle 7220 and rests against shoulder 7285. This further compresses spring 6200 and captures five steel balls 5400 between primary drive plate 5200 and secondary drive plate 5600. At this point, end 7290 of secondary spindle 7220 runs through hole 5205 of primary drive plate 5200 and projects into slot 5220. This exposes end 7290 and retainer groove 7300 within slot 5220 so chamfer washer 5180 and wire-form retainer ring 5160 can be mounted onto secondary spindle 7220 inside slot 5220.

Thus, the entire assembly is locked in place by inserting wire-form retainer ring 5160 into retainer groove 7300 of secondary spindle 7220. The chamfer in chamfer washer 5180 is located on the outside surface (not shown) where it will bear against wire-form retainer ring 5160. The chamfer causes wire-form retainer ring 5160 to be compressed deeper into retainer groove 7300 as pressure from primary drive plate 5200 may increase. This offers greater holding strength than a snap ring (such as snap ring 6400). This completes the assembly of yieldable spindle extension 5140. Yieldable spindle extension 5140 is then coupled at slot 5220 to spindle 5040 of saw motor 5020, and is capable of transmitting rotational force at an extended distance while also yielding at excess spindle torque.

Yieldable spindle extension 5140 is housed within tube 5080. As previously explained, tube 5080 is inserted and fastened into opening 5060 of saw motor 5020. On the opposite end, tube 5080 is press-fit onto boss 7600 on the back side of fixed guard 7800 and fastened with three screws 8000 through three holes 8200.

Internal support for yieldable spindle extension 5140 is provided within fixed guard 7800 by ball bearing 7200 and bushing 8400. Bushing 8400 is press fit into a reamed counterbored hole 8600. Hole 8600 runs all the way to the back side of fixed guard 7800, where the counterbore (not shown) is located. Yieldable spindle extension 5140 is then inserted through the back side of fixed guard 7800 through hole 8600 and bushing 8400 until ball bearing 7200 seats in the back side counterbore. Two screws 7000 are fastened on top of ball bearing 7200 to fasten it within the counterbore. Thus, yieldable spindle extension 5140 becomes fastened to fixed guard 7800.

Fixed guard 7800 has a blade housing 8800 which contains cylindrical guard mount 9000. A torsion spring 9200 and movable guard 9800 are mounted onto cylindrical guard mount 9000. Torsion spring 9200 hooks on end 9400 into a hole inside blade housing 8800 (not shown) and on a hook 9600 to a hole 10000 on movable guard 9800. When movable guard 9800 is retracted (as during a cutting operation), tension builds in torsion spring 9200 which urges movable guard 9800 to re-extend back to a forward guarding position. Cylindrical guard mount 9000 has a snap ring groove 9100. Snap ring 10200 is seated into snap ring groove 9100 to hold movable guard 9800 and torsion spring 9200 in place.

The distal end of secondary spindle 7220 projects a sufficient distance into blade housing 8800 to expose flats 7300. Flats 7300 engage flats 10450 on solid blade driver 10400. Solid blade driver 10400 has a pair of solid cylindrical projections 10600. Cylindrical projections 10600 engage drive holes 10800 of blade 11000. Blade 11000 has an arbor 11200 which is precision countersunk on its outside surface to seat the pan-shaped head of blade screw 11400. Because blade screw 11400 is fully recessed into countersunk arbor 11200, blade 11000 has a flush face, and is able to cut as closely as possible to the inner wall of a toe-kick.

The explanation of how yieldable spindle extension 5140 can disengage itself from spindle 5040 of saw motor 5020 is as follows: Yieldable spindle extension 5140 is coupled to spindle 5040 by slot 5220 in primary drive plate 5200. When spindle 5040 turns, primary drive plate 5200 will turn, and rotational force will be transferred to secondary drive plate 5600 through five steel balls 5400. Under normal cutting conditions, spring 6200 will hold secondary drive plate 5600 with sufficient force against primary drive plate 5200 that five steel balls 5400 will be captured between the detents or other depressions on both drive plates, and will transfer force between them, acting as transfer members. However, as previously explained, the detents 5210, 5215 in primary drive plate 5200 are deeper than the corresponding detents in secondary drive plate 5600. The five steel balls 5400 protrude less than half their diameter from the inside face of primary drive plate 5200, and thus engage the opposite detents in secondary drive plate 5600 with less than half of the diameter of their surface. When force is applied, the surfaces of five steel balls 5400 which protrude from the inner face of primary drive plate 5200 act as a wedge or an inclined plane against the corresponding detents on secondary drive plate 5600. As greater force is applied, five steel balls 5400 will push secondary drive plate 5600 further away until they may become disengaged from secondary drive plate 5600. At excess spindle torque, primary drive plate 5200 and five steel balls 5400 will continue to spin (being more deeply socketed in detents 5210, 5215). The rest of yieldable spindle extension 5140 (as well as solid blade driver 10400 and blade 11000) will stop. This internally disengages yieldable spindle extension 5140, and dissipates the stored kinetic energy of the motor.

When motor power is sufficiently reduced, five steel balls 5400 will reseat within the shallower detents in secondary drive plate 5600. At such time, yieldable spindle extension 5140 is re-engaged, and normal cutting may continue.

As previously explained, primary drive plate 5200 and secondary drive plate 5600 each have five detents to hold five steel balls 5400. Four of these corresponding pairs of detents are concentric. However, the fifth pair of corresponding detents are formed on a shorter radius. The fifth pair of corresponding detents cause primary drive plate 5200 and five steel balls 5400 to spin at least one full turn before five steel balls 5400 will ratchet against the detents on secondary drive plate 5600. This reduces the number of damaging impacts that five steel balls 5400 may have on the detents in secondary drive plate 5600, extending the life of these components.

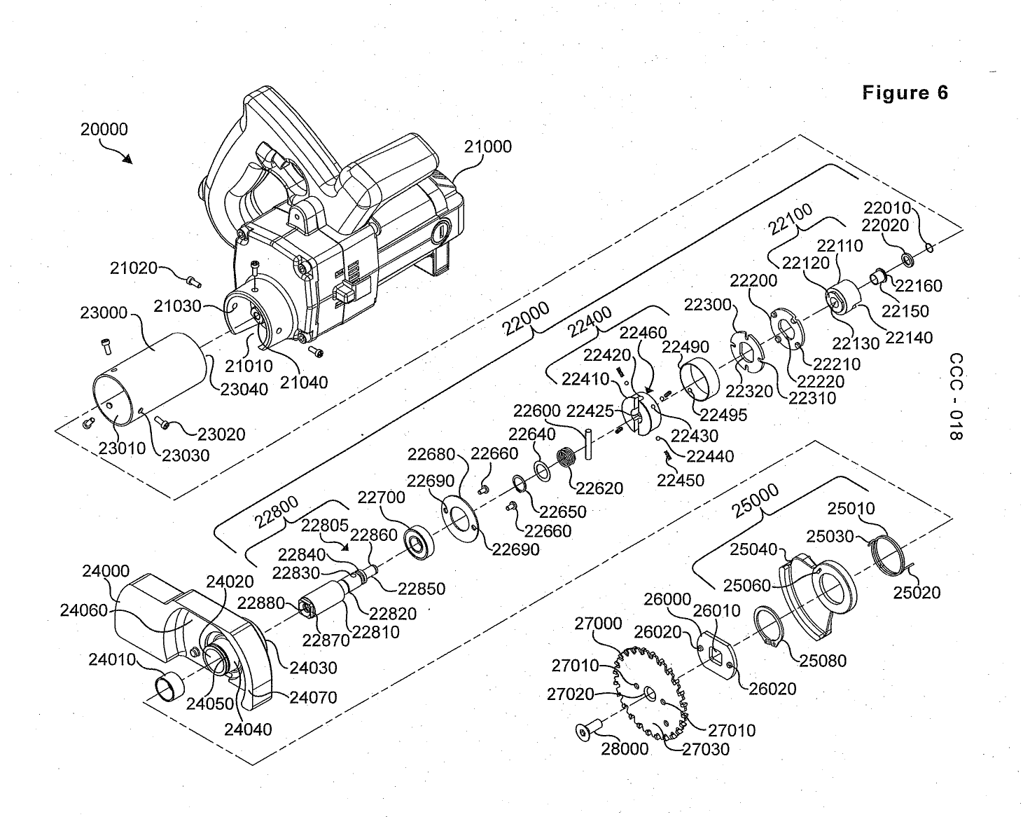

A yieldable spindle extension 22000 for a toe-kick saw 20000 is shown in FIG. 6. Toe-kick saw 20000 includes motor 21000, tube 23000, yieldable spindle extension 22000, fixed guard 24000, movable guard assembly 25000, blade driver 26000, blade 27000, and pan head screw 28000.

Yieldable spindle extension 22000 includes wire form retainer ring 22010, chamfer washer 22020, spindle coupler assembly 22100, male drive plate 22200, female drive plate 22300, spring assembly 22400, drive pin 22600, return spring 22620, washer 22640, snap ring 22650, bearing retainer plate screws 22660, bearing retainer plate 22680, ball bearing 22700, and secondary spindle 22800.

The assembly of toe-kick saw 20000 begins with the attachment of certain components to fixed guard 24000. A bushing 24010 providing precision support for secondary spindle 22800 is pressed into one end of a hole 24020 through fixed guard 24000. On the opposite end of hole 24020 is a counterbore (not shown) which accepts ball bearing 22700.

Secondary spindle 22800 is inserted into fixed guard 24000 through bushing 24010 and ball bearing 22700. End 22805 of secondary spindle 22800 extends out the back side of fixed guard 24000. Next ball bearing 22700 is fastened to fixed guard 24000 by placing ball bearing retainer plate 22680 on ball bearing 22700 and fastening it down with screws 22660 through holes 22690. Snap ring 22650 is then inserted into snap ring groove 22820 of secondary spindle 22800, thereby holding secondary spindle 22800 in fixed blade guard 24000.

Washer 22640 is placed on secondary spindle 22800 against snap ring 22650, followed by return spring 22620. Washer 22640 provides a footing for one end of return spring 22620, protecting ball bearing 22700 from wear. Drive pin 22600 is inserted into a hole 22830 in secondary spindle 22800.

Spring assembly 22400 includes spring body 22410, four balls 22440, four ball springs 22450, and spring assembly cover 22490. Spring body 22410 includes spring body drive slot 22420, secondary spindle through hole 22425, and four ball through holes 22430. Drive pin 22600 inserts within spring body drive slot 22420 of spring body 22410.

The spring body drive slot 22420 in spring body 22410 is deep enough to allow travel of spring assembly 22400 in the direction of fixed guard 24000. This is required for disengagement of female drive plate 22300 from male drive plate 22200 (discussed below).

The way that spring assembly 22400 is assembled with four balls 22440 and four ball springs 22450 is as follows: First, spring body 22410 is positioned on secondary spindle 22800 such that its four ball through holes 22430 align with ball groove 22840 in secondary spindle 22800. Spring assembly cover 22490 is slid over spring body 22410 with an access hole 22495 aligned with one of the four ball through holes 22430. One of the four balls 22440 is inserted through access hole 22495 into this one of the four ball through holes 22430, followed by one of the four ball springs 22450.

Spring assembly cover 22490 is turned so that the access hole 22495 is moved over another one of four ball through holes 22430. The second of four balls 22440 and four ball springs 22450 is inserted, and afterwards spring assembly cover is turned over another of the four ball through holes 22430. The process is repeated another two times until all of four balls 22440 and four ball springs 22450 are inserted and held within the four ball through holes 22430. Spring assembly 22400 is then held in position on secondary spindle 22800 by four balls 22440 being held within ball groove 22840 of secondary spindle 22800 by pressure from four ball springs 22450.

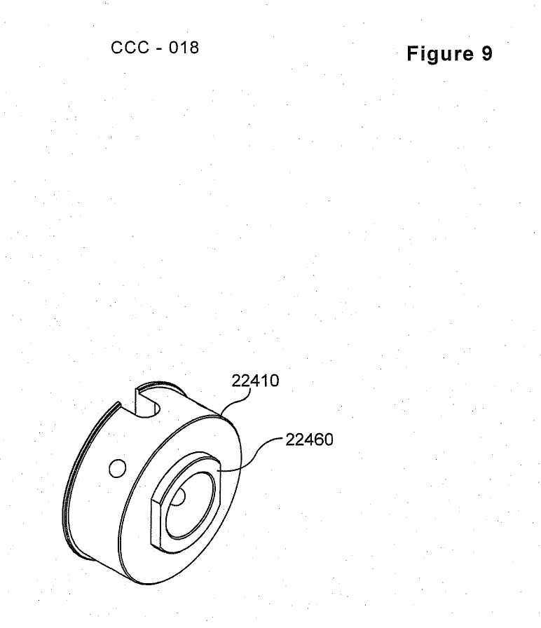

Female drive plate 22300 with four female slots 22310 is placed on secondary spindle 22800. A “double-D” internal cutout 22320 in female drive plate 22300 is inserted onto an outer “double-D” feature 22460 of spring body 22410 (FIG. 9).

Next male drive plate 22200 with four male nubs 22210 is placed on secondary spindle 22800. The four male nubs 22210 insert within the four female slots 22310 of female drive plate 22300. Male drive plate 22200 has a “double-D” internal cutout 22220.

Each of the nubs 22210 acts as a transfer member projecting from the male drive plate 22200, to transfer rotation force and energy from the male drive plate 22200 to the female drive plate 22300. Each of the four female slots 22310 act as a detent of the female drive plate 22300.

In a variation, the locations and couplings of the male and female drive plates are swapped. Female drive plate 22300 is coupled to a spindle coupler (such as spindle coupler 22100 discussed below), which is coupled to the motor spindle. The male drive plate 22200 is placed on the secondary spindle 22800 and coupled as by driving elements such as the “Double-D” feature 22460 of spring body 22410 (FIG. 9), drive slot 22420 of spring body 22410, and drive pin 22600 in secondary spindle 22800.

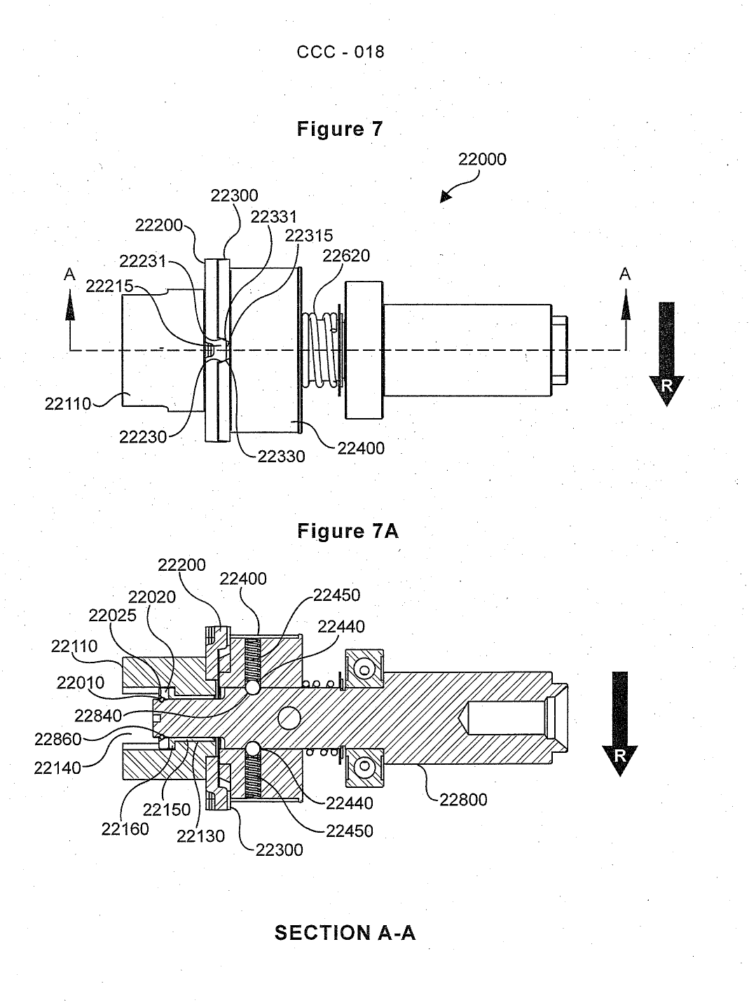

Spindle coupler assembly 22100 must be subassembled using a spindle coupler 22110 and a bushing 22150. Spindle coupler 22110 has a “double-D” drive surface 22120, through hole 22130, and drive slot 22140. As better viewed in FIG. 7A, a cross section of yieldable spindle extension 22000, through hole 22130 of spindle coupler 22110 opens into drive slot 22140.

As shown in FIG. 6, bushing 22150 has a shoulder 22160. As shown in FIG. 7A, bushing 22150 is pressed into through hole 22130 in drive slot 22140 of spindle coupler 22110. Bushing shoulder 22160 bottoms against the bottom of drive slot 22140. As shown in FIG. 6, the completed spindle coupler assembly 22100 can be placed on step 22850 of secondary spindle 22800.

As shown in FIG. 6, all the yieldable spindle extension components described thusfar are fastened on to secondary spindle 22800 by chamfer washer 22020 and wire form retainer ring 22010. Chamfer washer 22020 is placed on step 22850 past retainer groove 22860 of secondary spindle 22800. As best seen in FIG. 7A, the chamfer 22025 of chamfer washer 22020 faces outward. Wire-form retainer ring 22010 is inserted into retainer groove 22860.

As shown in FIG. 6, during disengagement of male drive plate 22200 and female drive plate 22300 (discussed below), chamfer washer 22020 and wire form retainer ring 22010 must hold spindle coupler 22100 and male drive plate 22200 in a horizontally stationary position. This is so that male drive plate 22200 can pressure a movable female drive plate 22300 away, disengaging female drive plate 22300 from male drive plate 22200. In the process, the pressure on wire form retainer ring 22010 and chamfer washer 22020 from male drive plate 22200 is great. As shown in FIG. 7A, this pressure is handled by the chamfer 22025 of chamfer washer 22020 compressing wire form retainer ring 22010 into the outer wall of retainer groove 22860. The capacity of wire form retainer ring 22010 to resist such pressure when in compression by chamfer washer 22020 is greater than that of a snap ring such as snap ring 22650 (FIG. 6).

As shown in FIG. 6, once that fixed guard 24000 and yieldable spindle extension 22000 are subassembled, tube 23000, and motor 21000 must be assembled with them. Tube 23000 is fastened at end 23010 to a boss 24030 of fixed blade guard 24000 with three screws 23020 through three holes 23030. Tube 23000 is fastened at an opposite end 23040 to motor 21000 at an opening 21010. In the process, yieldable spindle extension 22000 is connected at drive slot 22140 of spindle coupler 22110 to spindle 21040 of saw motor 21000. Tube 23000 is then fastened to motor 21000 with three screws 21020 running through three holes 21030.

To complete the assembly of toe-kick saw 20000, movable guard assembly 25000 is assembled onto fixed guard 24000 at cylindrical guard mount 24040. Movable guard assembly 25000 includes a torsion spring 25010, movable guard 25040, and snap ring 25080. Torsion spring 25010 is inserted onto cylindrical guard mount 24040 with a pointed end 25020 inserted within a hole (not shown) in fixed guard 24000. Next movable guard 25040 is inserted onto cylindrical guard mount 24040 with a hooked end 25030 of torsion spring 25010 attached at torsion spring hole 25060. Movable guard 25040 and torsion spring 25010 are fastened on cylindrical guard mount 24040 by inserting snap ring 25080 into snap ring groove 24050 of fixed guard 24000.

A blade driver 26000 and blade 27000 are fastened onto secondary spindle 22800. Secondary spindle 22800 has four drive flats 22870 forming a square drive surface on its distal end. When secondary spindle 22800 is fastened to fixed guard 24000, these four drive flats 22870 extend from the edge of bushing 24010 in hole 24020. In this position, the four drive flats 22870 form a square-shaped drive mount for blade driver 26000. The square cutout 26010 of blade driver 26000 mounts on four drive flats 22870 in this position.

Blade driver 26000 has two drive nubs 26020. Blade 27000 is placed on blade driver 26000 with drive nubs 26020 inserted into two drive holes 27010 in blade 27000. Blade 27000 has a countersunk arbor 27020. Pan head screw 28000 is put through countersunk arbor 27020 and tightened within tapped hole 22880 of secondary spindle 22800 to fasten blade 27000. Pan head screw 28000 once fully tightened is flush within countersunk arbor 27020 of blade 27000. This forms a flush outer surface 27030 on blade 27000 capable of cutting as close as possible to an inner wall of a toe space area. The plane of flush outer surface 27030 of blade 27000 is also flush with the outer surface 24070 of fixed guard 24000, again to enable blade 27000 to cut as close as possible to the inner wall of a toe space area.

An explanation of how yieldable spindle extension 22000 can provide the torque required for normal cutting is as follows: FIG. 7 is an assembled top view of yieldable spindle extension 22000 in isolation. Male drive plate 22200 and female drive plate 22300 are fully engaged as in normal cutting. A male nub 22215 illustrated in FIG. 7 (typical of four male nubs 22210 in male drive plate 22200 as shown in FIG. 6) is formed with male angled surfaces 22230, 22231. As shown in FIG. 6, blade 27000 cuts by turning counterclockwise. Therefore, motor spindle 21040, male drive plate 22200, and the four male nubs 22210 turns counterclockwise. In FIG. 7, the direction of rotation is indicated by arrow “R”. Accordingly, male angled surface 22230 is the driving surface.

A female slot 22315 which is illustrated in FIG. 7 (typical of four female slots 22310 in female drive plate 22300 as shown in FIG. 6) has female angled surfaces 22330, 22331. As female drive plate 22300 also turns counterclockwise, female angled surface 22330 is the driving surface.

As shown in FIG. 7, driving male angled surface 22230 works with the driving female angled surface 22330 based on the principle of an inclined plane. As torque increases, a driving male angled surface 22230 of the horizontally stationary male drive plate 22200 gradually “wedges” and separates the movable female drive plate 22300 because of the inclined plane of driving female angled surface 22330.

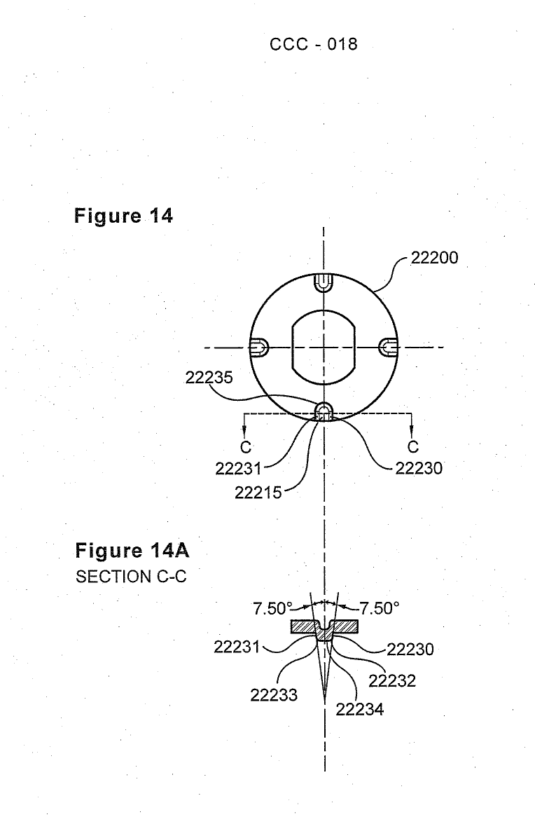

FIG. 14 is a top view of male drive plate 22200 showing greater detail of male nub 22215 and the male angled surfaces 22230, 22231 of FIG. 7. FIG. 14A shows Section C-C of male nub 22215 and how each of male angled surfaces 22230, 22231 form an angle of about 7.5 degrees in relation to a vertical plane that bisects male drive nub 22215.

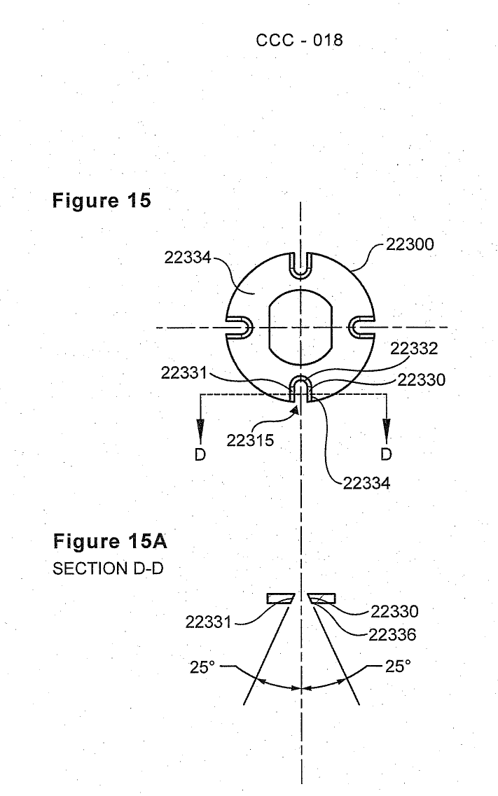

As further detailed in Section C-C of FIG. 14A, male angled surfaces 22230, 22231 transition to a flat top surface 22234 at two radiused edges 22232, 22233. Radius edge 22232 is a driving radiused edge. When male drive plate 22200 is disengaged from female drive plate 22300 (FIG. 6), the flat top surface 22234 of male nub 22215 slides with minimum resistance over a face 22334 (FIG. 15) of female drive plate 22300 (FIG. 7). As shown in FIG. 14, male nub 22215 is rounded at a back end 22235.

As shown in Section C-C of FIG. 14A, the male nub 22215 is formed at an about 7.5 degree angle in relation to a vertical plane that bisects male drive nub 22215. This angle is as steep as practical from a forming standpoint such that a driving radiused edge 22232 will contact a driving female angle surface 22230 (FIG. 7) at a point that is as deep as possible within driving female angled surface 22330 (FIG. 7). As will be explained below, this gives both male drive plate 22200 (FIG. 7) and female drive plate 22300 (FIG. 7) the greatest long-term impact wear.

FIG. 15 is a top view of the female drive plate 22300 of FIG. 7 showing greater detail of female slot 22315 and female angled surfaces 22330, 22331. FIG. 15A shows Section D-D of female slot 22315 and how each of female angled drive surfaces 22330, 22331 form an angle of about 25 degrees in relation to a vertical plane that bisects female slot 22315. As will be explained below, this 25 degree angle is optimal for driving female angled surface 22330 to transmit enough torque for normal cutting. However, in the event of excess spindle torque, the 25 degree angle will also cause female drive plate 22300 to be pressured apart and disengage from male drive plate 22200 (FIG. 7). Beyond angled surfaces 22330, 22331, female slot 22315 is rounded at end 22332 to accept the rounded back end 22235 of male nub 22215 (FIG. 14).

Returning to FIGS. 7 and 7A and the explanation of yieldable spindle extension 22000 under normal cutting conditions, the way that spring assembly 22400 holds female drive plate 22300 against male drive plate 22200 is as follows: FIG. 7A shows cross section A-A of the yieldable spindle extension 22000 of FIG. 7 with two of the four balls 22440 within spring assembly 22400 being held in a ball groove 22840 by two of the four ball springs 22450. Any outward motion of female drive plate 22300 away from male drive plate 22200 causes the four balls 22440 to be pressured up or elevate on the incline of ball groove 22840. This incline will also be referred to herein as an inclined surface of secondary spindle 22800. Any climbing motion of the four balls 22440 is in turn opposed by the four ball springs 22450. So long as the four balls 22440 can remain in ball groove 22840, female drive plate 22300 will remain in an engaged condition with male drive plate 22200, and normal cutting can continue.

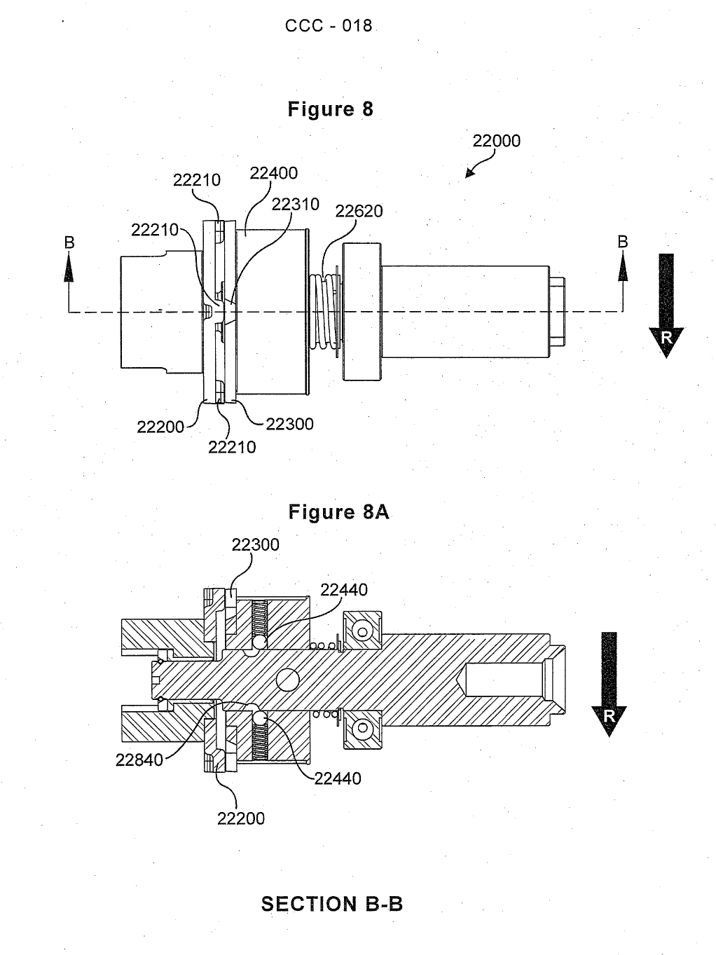

At excess spindle torque, female drive plate 22300 enters a disengaged condition with male drive plate 22200 as follows: FIG. 8 is another top view of yieldable spindle extension 22000, but with male drive plate 22200 and female drive plate 22300 disengaged. FIG. 8A shows Section B-B of the cross section of the yieldable spindle extension 22000 of FIG. 8 with two of the four balls 22440 having exited the incline of ball groove 22840. In this position, two of the four balls 22440 can no longer provide sufficient force or pressure to hold female drive plate 22300 in an engaged condition with male drive plate 22200. The force generated by male drive plate 22200 causes female drive plate 22300 to enter a disengaged condition with male drive plate 22200.

As shown in FIG. 6, when male drive plate 22200 and female drive plate 22300 enter a disengaged condition, motor spindle 21040, spindle coupler assembly 22100, and male drive plate 22200 can continue to turn. However, male drive plate 22200 can no longer transmit force through female drive plate 22300. Secondary spindle 22800 and blade 27000 will temporarily stop from blade resistance at the saw kerf.

As shown in FIG. 8, as female drive plate 22300 becomes disengaged from male drive plate 22200, return spring 22620 becomes compressed. Return spring 22620 reacts by pressuring spring assembly 22400 along with female drive plate 22300 back against male drive plate 22200. Return spring 22620 may be weaker than spring assembly 22400 would be under normal cutting conditions in its ability to pressure female drive plate 22300 against male drive plate 22200. Therefore, in the disengaged condition, the reduced pressure of return spring 22620 reduces the force of impact of the driving male angled surface 22230 (FIG. 7) of the four male nubs 22210 (FIG. 6) against the driving female angled surface 22330 (FIG. 7) of the four female slots 22310 (FIG. 6) of female drive plate 22300 (FIG. 7). This improves the impact wear of these components.

Thus, the return spring 22620 is a portion of a first biasing mechanism that presses the female drive plate 22300 towards the male drive plate 22200. The return spring 22620 extends and collapses coaxially with the secondary spindle 22800, i.e. in a direction that parallels the central axis of the secondary spindle 22800. Other biasing mechanisms with similar characteristics may be devised, such as mechanisms having two or more springs operating in tandem or parallel, other types of springs besides coil springs, or another compressed member.

Further, the four balls 22440, the ball springs 22450, the ball groove 22840 on the secondary spindle 22800 and various supporting members of the spring assembly 22400 are a portion of a second biasing mechanism. This second biasing mechanism provides a force or a pressure that differs depending on the relative positions of the balls 22440 and the ball groove 22840 and corresponding relative positions of the male drive plate 22200 and the female drive plate 22300. The ball groove 22840 is positioned on the secondary spindle 22800 so that the balls 22440 travel out of the groove and past the incline of the ball groove 22840 as the male drive plate 22200 and the female drive plate 22300 disengage. Thus, at least one ball 22440 urges the spring assembly 22400 at a first force against the female drive plate 22300 when the plates and the yieldable spindle extension 22000 are in an engaged or coupled condition. When the plates 22300 and 22200 and the yieldable spindle extension 22000 are in a disengaged or decoupled condition, the balls 22440 no longer engage the incline or other portion of the ball groove 22840, and the second biasing mechanism urges the spring assembly 22400 against the female drive plate with a second force that is less than the first force. As the spring assembly 22400 is located opposite to the male drive plate 22200, relative to the female drive plate 22300, forces or pressures exerted by the spring assembly 22400 on the female drive plate 22300 press the female drive plate 22300 towards the male drive plate 22200. Other ball receiving areas besides the ball groove 22840 may be devised, as may other biasing elements besides springs. The first and second biasing mechanisms may be expressed separately or combined into a single biasing mechanism.

As shown in FIG. 6, in the disengaged condition, male drive plate 22200 continues turning with motor spindle 21040. At each quarter turn, the four male nubs 22210 will impact the four female slots 22310. This impact dissipates the stored kinetic energy in the motor 21000. However, the impact of a topmost radiused edge of the male drive nubs 22210 (such as driving radiused edge 22232 of FIG. 14A) against a topmost edge of a female slot 22310 (such as a topmost edge 22336 of drive female angled surface 22330 of FIG. 15A) gradually wears these surfaces until they lose their original angles.

The following is an explanation of how features of the male drive plate and female drive plate provide improved impact wear: As shown in FIG. 7, when male drive plate 22200 and female drive plate 22300 return to an engaged condition, it is preferred that a driving radiused edge 22232 (FIG. 14) of a driving male angled surface 22230 reengages the driving female angled surface 22330 at a point which is as deep as possible within the female slot 22315. This ensures that the driving male angle surface 22230 will contact the driving female angled surface 22330 at a portion of driving female angled surface 22330 that is as least worn as possible, ensuring the components can transmit torque after being in as many disengaged conditions as possible.

As shown in FIG. 6, when the energy of the motor 21000 is sufficiently reduced, the four male nubs 22210 of male drive plate 22200 can reengage the four female slots 22310 of female drive plate 22300. Normal cutting can resume.

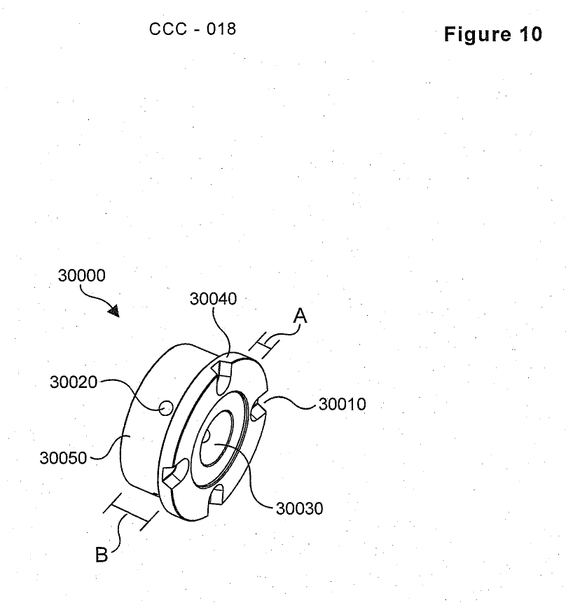

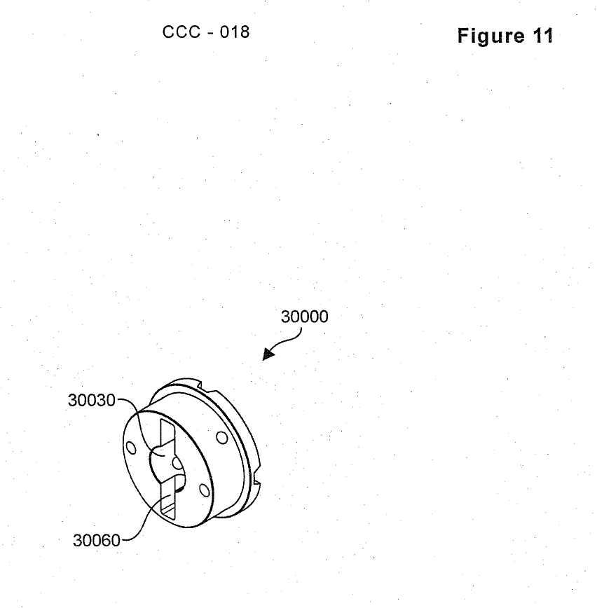

In one alternative, the spring body and female drive plate can be combined into one part by means of powdered metal manufacturing methods. FIG. 10 shows a female spring body 30000 having four female slots 30010, four ball through holes 30020, and a secondary spindle through hole 30030. In this embodiment, dimension A connotes a female plate portion 30040 of the female spring body 30000 including four female slots 30010. Dimension B connotes a female body portion 30050 including four ball through holes 30020. FIG. 11 shows a reverse angle of female spring body 30000 showing drive slot 30060 and secondary spindle through hole 30030.

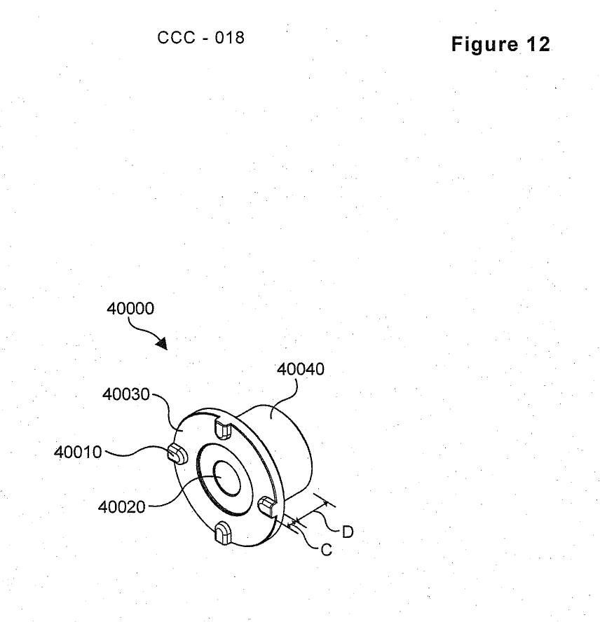

In another alternative, the male drive plate and spindle coupler can be combined into one part by means of powdered metal manufacturing methods. FIG. 12 shows a male coupler 40000 having four male nubs 40010. Male coupler has a secondary spindle through hole 40020. Dimension C connotes the male plate portion 40030. Dimension D connotes a male spindle coupler portion 40040.

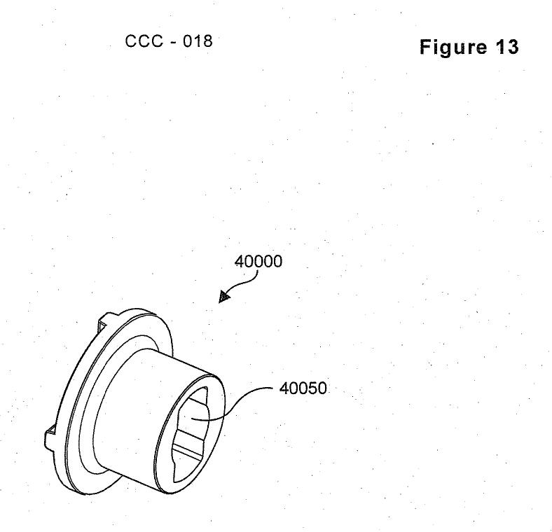

FIG. 13 shows a reverse angle of male coupler 40000 showing a drive slot 40050. The secondary spindle through hole 40020 (FIG. 12) opens into the middle of drive slot 40050. This allows the extension of secondary spindle 22800 (FIG. 6) into drive slot 40050, such that chamfer washer 22020 and wire form retainer ring 22010 (FIG. 6) can be mounted on secondary spindle 22800 (FIG. 6) within drive slot 40050.

What is claimed is:

1. A toe-kick saw, comprising:
a saw motor having a spindle;
a yieldable spindle extension, including:
a first drive plate operatively connected to said saw motor spindle;
a second drive plate that engages and disengages from said first drive plate;
one or more transfer members projecting from one of said first drive plate or said second drive plate and insertable within a corresponding one or more depressions of the other of said first drive plate or said second drive plate;
a spring yieldably pressing said second drive plate against said first drive plate;
a secondary spindle having a longitudinal axis on which said first drive plate, said second drive plate, and said spring are positioned, said secondary spindle passing through and retaining said first drive plate such that said first drive plate can spin on said secondary spindle in a disengaged condition of said yieldable spindle extension, said secondary spindle including a blade fastener hole;
a blade mount operatively connected to said secondary spindle for driving a blade; and
a blade fastener securable into said blade fastener hole of said secondary spindle;
wherein when a circular saw blade is mounted on said blade mount and secured by said blade fastener, an engaged condition of said yieldable spindle extension includes said first drive plate, said second drive plate, and said secondary spindle spinning with said saw motor spindle, such that said blade mount and said circular saw blade are spinning with said saw motor spindle, and a disengaged condition of said yieldable spindle extension includes said first drive plate spinning with said saw motor spindle and includes said second drive plate, and said secondary spindle being stopped, such that said blade mount and said circular saw blade are stopped.

2. The toe-kick saw of claim 1 wherein:
said engaged condition includes said one or more transfer members being inserted within said corresponding one or more depressions engaging said first drive plate and said second drive plate; and
said disengaged condition includes said one or more transfer members exiting from said corresponding one or more depressions, disengaging said first drive plate and said second drive plate.

3. The toe-kick saw of claim 1 wherein each of said one or more transfer members includes a nub.

4. The toe-kick saw of claim 1 wherein:
said secondary spindle further includes an inclined surface; and
said yieldable spindle extension further includes at least one ball engageable with said inclined surface.

5. The toe-kick saw of claim 4 wherein:
said at least one ball is at least partially held on said inclined surface in the engaged condition of the yieldable spindle extension; and
said at least one ball moves beyond said inclined surface in the disengaged condition of the yieldable spindle extension.

6. The toe-kick saw of claim 4 wherein said at least one ball is spring loaded.

7. A toe-kick saw, comprising:
a saw motor having a spindle;
a yieldable spindle extension, including:
a spindle coupler operatively connected to said saw motor spindle;
a first drive plate operatively connected to said spindle coupler;
a second drive plate that engages with and disengages from said first drive plate;
a biasing mechanism yieldably urging said second drive plate against said first drive plate;
a secondary spindle having a longitudinal axis on which said spindle coupler, said first drive plate, said second drive plate, and said biasing mechanism are positioned, said secondary spindle passing through and retaining said first drive plate such that said first drive plate can spin on said secondary spindle in a disengaged condition of said yieldable spindle extension, said secondary spindle including a blade fastener hole;
a blade mount operatively connected to said secondary spindle for driving a blade; and
a blade fastener securable into said blade fastener hole of said secondary spindle;
wherein when said second drive plate is engaged with and turned by said first drive plate, said secondary spindle is turned; and
wherein one of said first drive plate or said second drive plate includes one or more male nubs engageable within a corresponding one or more female slots on the other of said first drive plate or second drive plate; and
wherein when a circular saw blade is mounted on said blade mount and secured by said blade fastener, said yieldable spindle extension has an engaged condition that includes said first drive plate, said second drive plate, and said secondary spindle spinning with said saw motor spindle, such that said blade mount and said circular saw blade are spinning with said saw motor spindle, and said yieldable spindle extension has a disengaged condition that includes said first drive plate spinning with said saw motor spindle, and includes said second drive plate and said secondary spindle being disengaged from said first drive plate, such that said blade mount and said circular saw blade are not turned by said secondary spindle.

8. The toe-kick saw of claim 7, wherein:
said biasing mechanism includes a spring assembly having a spring body, at least one ball, and at least one ball spring; and
said secondary spindle further includes an inclined surface such that in said engaged condition, said at least one ball contacts said inclined surface and said spring assembly is urged at a first force against said second drive plate, and in said disengaged condition, said at least one ball travels beyond said inclined surface, and said spring assembly is urged against said second drive plate at a second force that is reduced from said first force.

9. The toe-kick saw of claim 8, wherein said spring body and said second drive plate are formed from a single piece of material.

10. The toe-kick saw of claim 8, wherein said biasing mechanism further includes a compressible member that is compressed along said longitudinal axis of said secondary spindle by said second drive plate moving from said engaged condition with said first drive plate to said disengaged condition from said first drive plate, such that as said compressible member is compressed, said compressible member urges said spring body and said second drive plate to said engaged condition with said first drive plate.

11. The toe-kick saw of claim 7, wherein said spindle coupler and said first drive plate are formed from a single piece of material.

12. The toe-kick saw of claim 7, wherein said female slot includes an angled surface of about 25 degrees.

13. The toe-kick saw of claim 7, wherein said male nub is formed at an angle of about 7.5 degrees.

14. The toe-kick saw of claim 7, wherein said circular saw blade includes a countersunk arbor, and said blade fastener is a pan head screw threadable into said blade fastener hole in said secondary spindle, such that said pan head screw forms a flush surface with an outer face of said circular saw blade.

15. A toe-kick saw, comprising:
a saw motor having a spindle;
a yieldable spindle extension, including:
a first drive plate driven by the saw motor spindle;
a second drive plate that engages with and disengages from said first drive plate;
a secondary spindle drivable by said second drive plate such that when said second drive plate is engaged with and turned by said first drive plate, said secondary spindle is turned, said secondary spindle including a blade fastener hole;
a biasing mechanism including a spring assembly, having:
a spring body;
at least one ball, and
at least one ball spring,
wherein said spring body and said ball spring are configured to movably position said at least one ball in contact with an inclined surface, such that when said at least one ball contacts said inclined surface, said spring assembly is urged at a first force against said second drive plate, and such that when said at least one ball moves beyond said inclined surface, said spring assembly is urged against said second drive plate at reduced force from the first force;
a blade mount operatively connected to the secondary spindle for driving a blade;
a blade fastener securable into said blade fastener hole of said secondary spindle;
wherein said secondary spindle has a longitudinal axis on which said first drive plate, said second drive plate and said biasing mechanism are positioned, said secondary spindle passing through and retaining said first drive plate such that said first drive plate can spin on said secondary spindle in a disengaged condition of said yieldable spindle extension; and
wherein when a circular saw blade is mounted on said blade mount and secured by said blade fastener, an engaged condition of said yieldable spindle extension includes said second drive plate being urged against said first drive plate at said first force when said at least one ball of said spring assembly contacts said inclined surface, such that said first drive plate, said second drive plate, said secondary spindle, and said biasing mechanism are spinning with said saw motor spindle, such that said blade mount, and said saw circular saw blade are spinning with said saw motor spindle, and a disengaged condition of said yieldable spindle extension includes said second drive plate being urged against said first drive plate at a reduced force from said first force when said at least one ball travels beyond said inclined surface, such that said first drive plate spins with said saw motor spindle, and said second drive plate, said secondary spindle, said biasing mechanism are disengaged from said first drive plate, such that said blade mount, and said circular saw blade are not turned by said secondary spindle.

16. The toe-kick saw of claim 15, wherein said biasing mechanism further includes a compressible member that is compressed along a longitudinal axis of said secondary spindle by said second drive plate moving from said engaged condition with said first drive plate to said disengaged condition from said first drive plate, such that as said compressible member is compressed, said compressible member urges said spring body and said second drive plate to said engaged condition with said first drive plate

17. The toe-kick saw of claim 15 wherein one of said first or second drive plates includes a nub including an angled surface.

18. The toe-kick saw of claim 15 wherein one of said first or second drive plates includes a female slot including an angled surface.
